(19) United States
(12) Patent Application Publication
(10) Pub. No.: US 2017/0075513 A1
(43) Pub. Date: Mar. 16, 2017

(54) Surf Software

(71) Applicants: Ryan Watson, Chantilly, VA (US); Kapetanakis Elaine, Chantilly, VA (US)

(72) Inventors: Ryan Watson, Chantilly, VA (US); Kapetanakis Elaine, Chantilly, VA (US)

(21) Appl. No.: 14/709,259

(22) Filed: May 11, 2015

(51) Int. Cl. G06F 3/0482; G06F 17/30

(52) U.S. Cl. CPC G06F 3/0482; G06F 17/30197; G06F 17/30129; G06F 17/30557

(57) ABSTRACT

Disclosed herein is a computer implemented method for intelligent management of a plurality of active data files in a plurality of the systems, operated upon by a plurality of active applications, comprising: identifying said plurality of active data files in a plurality of the system, operated upon by a plurality of active applications which are operably connected to said computer; retrieving said identified plurality of active data files of said file system which is operated upon by said active applications which are operably connected to said computer; grouping said plurality of active data files into a list using an algorithm; storing in a storage medium of said computer said retrieved plurality of active data files operated upon in a plurality of active applications operably connected to said computer; displaying through a graphical user interface, said grouped files on a display means of said computer.

### CROSS REFERENCE TO RELATED APPLICATIONS

Not applicable.

### FEDERALLY SPONSORED RESEARCH AND DEVELOPMENT

Not applicable.

### MICROFICHE

Not applicable

### BACKGROUND OF THE INVENTION

(1) Field of the Invention

The invention relates generally to a computer implemented method of conveniently operating a computing resource. More particularly to a system and a method of saving multiple browsing sessions and data files into a computer readable medium which could be revisited and utilized at a later time.

(2) Background

Users have today a possibility to reach and be reached by a vast amount of information on a variety of user devices through the World Wide Web. Such user devices include telephones, handheld devices, personal computers (PCs), personal digital assistants (PDAs), and the like. The information may be provided to the user in a push mode, that is, information is provided to the user without a specific action on the user's side. In general, the user attempts to receive relevant information that provides the user with significant insights into the areas of interest to the user. The World Wide Web however, is a graphical and interactive interface for the Internet. There are different web browsing clients on a data processing system commonly referred as computers which are connected to the Internet that are utilized to access servers connected to the Web. The program on the server is generally termed a “website.” Websites are a collection of “web pages,” where web pages are graphic displays which are usually linked together and may be downloaded to a data processing system utilizing a browser client. Each web page has a unique address, or Universal Resource Locator (URL) within the Web that is accessible by utilizing Transfer Control Protocol/internet Protocol (TCP/IP) transactions via telecommunication networks and a modem. The address allows Internet “browser” clients (computer program applications) to connect and communicate with a Hypertext Transfer Protocol (HTTP) server over the Web.

In several instances, users have visited useful websites and retained useful bookmarks. However, the user often forgets to add the web page to the bookmark list or, adds the bookmark but forgets the title of the site. The browser client history file automatically records each web page visited and retains it for a period of time specified by the browser developer or user. Also users don't know about the history record that is automatically stored and even if they did, the record is entered in no particular order, thus making it very hard to search. Furthermore, URLs may not be descriptive and if a user knew there was a subject that the user wanted to re-visit, it would be difficult to impossible to find that address in the history record. Even though an ASCII search may be made of both the bookmark and history records, the URLs included may not provide any clues as to the link between the desired subject and a web page. Additionally, there are “off-line” browsers that utilize the browser client to search specified sites for key parameters, but the user must enter an identification of the pages to be searched. Also, there are stand-alone off-line browsers that automatically access specified web pages unattended or in the background and download the web pages.

Therefore it will be desirable to provide a method and system that can save multiple tabs in a window allowing a user to do a topical search, allow a user to do a more efficient search in the web and aid the user in handling more information.

### BRIEF SUMMARY OF THE INVENTION

Primarily, an invention is computer implemented method for intelligent management of a plurality of active data files in a plurality of file systems, operated upon by a plurality of active applications that comprising of steps wherein the method identifies the plurality of active data files in a plurality of file system, operated upon by a plurality of active applications which are operably connected to said computer; thereafter the method retrieves the identified plurality of active data files of said file system which is operated upon by the active applications which are operably connected to said computer. A grouping of the plurality of active data files using an algorithm, the algorithm is based on user interaction with an active data file from said one or more data files and on metadata describing said active data file, further the metadata comprises document type, document access history, document edit history, keywords, or author information. Further the method stores the retrieved plurality of active data files operated upon by a plurality of active applications operably connected to the computer, in a memory of the computer and displays the grouped active data file through a graphical user interface on said grouped files on a display means of said computer.

In another embodiment of the present invention provides a computer implemented method and a system for more convenient online and offline researching or working with a computing resource like a smart phone, PC or a smart PDA. The method in yet another embodiment provides a computer implemented method and a system for performing a topical search using a computing resource. The method also provides a means of saving in a computer readable medium all the URLs and active files of any accessed website or application visited or used at least one in the computing resource.

Additionally the invention provides a means for allowing access to a list with plurality of URLs of websites in the web browsing client application and the saved files of the different application of the computing resource. Moreover, the invention provides a means to compile the URLs and data files in a computer readable storage medium and to be accessed in the same window simultaneously in the web browsing client application. Moreover, the invention provides a means of creating, editing, adding and detecting of active data files from the list.

The summary is provided to introduce a selection of concepts in a simplified form that are further described below in the detailed description. This Summary is not intended to identify key features or essential features of the subject matter, nor is it intended to be used as an aid in determining the scope of the subject matter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an illustration of the working of the product in an android-based mobility.

FIG. 2 is an illustration of the concept for the tool/application's information delivery in mobility.

FIG. 3 is an illustration of how to find the application in a windows environment.

### DETAILED DESCRIPTIONS OF THE INVENTION

The following is a detailed description of example embodiments of the invention depicted in the accompanying drawings. The example embodiments are in such detail as to dearly communicate the invention. However, the amount of detail offered is not intended to limit the anticipated variations of embodiments; but, on the contrary, the intention is to cover all modifications, equivalents, and alternatives falling within the spirit and scope of the present invention. The detailed descriptions below are designed to make is such embodiments obvious to a person of ordinary skill in the art.

The present invention can be implemented on any communication device that has hardware components that can perform telecommunication such as (but not limited to)—computers (desktop, laptop, tablets), smart phones, personal multimedia devices, etc.

The various devices on which the applications that implement the present invention run may use one or more processors with different instruction-sets, architectures, clock-speeds, etc. and memory that may include high speed random access memory and may include non-volatile memory such as one or more magnetic disk storage devices, flash memory devices and other kinds of solid state memory devices.

The various applications that can implement the present invention run on electronic devices that may use at least one physical user interface device that provide the means of control and navigation within the operating system and applications that run on the devices include (but not limited to) touch-pads such as those described in (but not limited to)—(1) U.S. patent application Ser. No. 10/722,948 (“Touch pad for handheld device”, filed Nov. 25, 2003); (2) U.S. patent application Ser. No. 10/188,482 (“Touch pad for handheld device”, filed Mar. 21, 2006); (3) U.S. patent application Ser. No. 08/210,610 (“Computer system with touchpad support in operating system”, filed Mar. 18, 1994); (4) U.S. patent application Ser. No. 643,256 (“Movable touch pad with added functionality”, filed Ser. No. 10/643,256), touch screens such as those described in (but not limited to) (1) U.S. patent application Ser. No. 11/381,313, “Multipoint Touch Surface Controller,” filed on May 2, 2006; (2) U.S. patent application Ser. No. 10/840,862, “Multipoint Touchscreen,” filed on May 6, 2004; (3) U.S. patent application Ser. No. 10/903,964, “Gestures For Touch Sensitive Input Devices,” filed on Jul. 30, 2004; (4) U.S. patent application Ser. No. 11/048,264, “Gestures For Touch Sensitive Input Devices,” filed on Jan. 31, 2005; (5) U.S. patent application Ser. No. 11/038,590, “Mode-Based Graphical User interfaces For Touch Sensitive Input Devices,” filed on Jan. 18, 2005; (6) U.S. patent application Ser. No. 11/228,758, “Virtual Input Device Placement On A Touch Screen User Interface,” filed on Sep. 16, 2005; (7) U.S. patent application Ser. No. 11/228,700, “Operation Of A Computer With A Touch Screen Interface,” filed on Sep. 16, 2005; (8) U.S. patent application Ser. No. 11/228,737, “Activating Virtual Keys Of A Touch-Screen Virtual Keyboard,” filed on Sep. 16, 2005 and (9) U.S. patent application Ser. No. 11/367,749, “Multi-Functional Hand-Held Device,” filed on Mar. 3, 2006, click wheel such as those described in U.S. patent application Ser. No. 11/549,619 “Method, device, and graphical user interface for dialing with a click wheel” filed on Oct. 13, 2006, keyboards such as those mentioned in (but not limited to) U.S. patent application Ser. No. 07/711,760 (“Ergonomic keyboard input device”, filed on Jun. 6, 1991), mouse such as those described in (but not limited to) (1) application Ser. No. 09/167,314 (“Computer mouse with enhance control button(s)”, filed on Oct. 6, 1998); (2) application Ser. No. 08/288,945 (“Roller mouse for implementing scrolling in windows applications”, filed on Aug. 10, 1994) and gesture recognition means such as those described in (but not limited to) (1) European Patent application publication number: EP2482176 A2 (“Multi-input gesture control for a display screen”, filed on Nov. 4, 2011) and (2) U.S. Patent application with publication number 20120317511 A1 (“DISPLAY WITH BUILT IN 3D SENSING CAPABILITY AND GESTURE CONTROL OF TV”, filed on Aug. 21, 2012).

Display means used by these devices may use LCD (liquid crystal display) technology, LED (light Emitting Diode) technology, CRT (Cathode ray tube) technology, or LPD (light emitting polymer) technology or any other display technologies. Various realizations of graphics display circuitry that implement a Graphics Processing Unit (GPU) are used to achieve video interface between user and these electronic devices.

Connectivity of these devices with networks such as the internet, an intranet and/or wireless network such as cellular telephone network, a wired or wireless local area network (LAN) and/or metropolitan area network (MAN) and/or WAN (wide area network) and other wireless communication is achieved by use of a plurality of communication standards, protocols and technologies like Global System for mobile communication (GSM), Enhanced Data GSM Environment (EDGE), wideband code division of multiple access (W-CDMA), DLNA, LTE (Long Term Evolution), code division of multiple access (CDMA), time division multiple access (TDMA), Bluetooth, Wireless Fidelity (Wi-Fi) and/or any other suitable communication protocol, including communication protocols not yet developed as of the filing date of this document.

The present invention may be implemented on applications that run on a single or variety of operating system platforms including but not limited to OS X, WINDOWS, UNIX, IOS, ANDROID, SYMBIAN, LINUX, or embedded operating systems such as VxWorks.

The present invention may also be implemented to work with various web browsers including but not limited to Internet Explorer, Mozilla Firefox, Safari and Opera that access and handle various types of web pages constructed with various mark-up languages such as HTML, HTML-5, XHTML, XML, etc. and the associated CSS (cascading style sheet) files and java-script files.

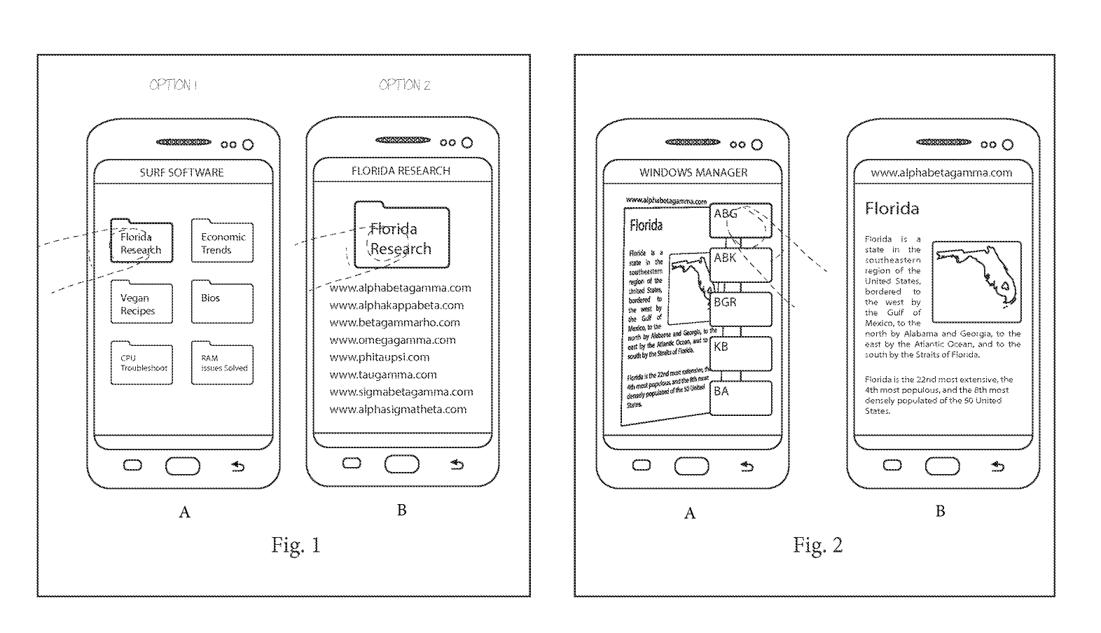

This invention is a method of intelligently managing of a plurality of active data files in a plurality of file systems, operated upon by a plurality of active applications that comprising of steps wherein the method identifies the plurality of active data files in a plurality of file system, operated upon by a plurality of active applications which are operably connected to said computer; thereafter the method retrieves the identified plurality of active data files of said file system which is operated upon by the active applications which are operably connected to said computer. A grouping of the plurality of active data files using an algorithm, the algorithm is based on user interaction with an active data file from said one or more data files and on metadata describing said active data file, further the metadata comprises document type, document access history, document edit history, keywords, or author information. Further the method stores the retrieved plurality of active data files operated upon by a plurality of active applications operably connected to the computer, in a memory of the computer and displays the grouped active data file through a graphical user interface on said grouped files on a display means of said computer. Referring to the drawings, and specifically to FIG. 1 thereof, is shown the graphical user interface in a mobile environment of the computing resource which will provide the user with the access to a management window, where the user will have access to list of stored active data files and URLs which are bundled in a group using an algorithm.

In an exemplary embodiment and with reference to FIG. 1, the invention aims to provide a means for a user to conveniently browse the World Wide Web, perform a topical search on the World Wide Web, research the online contents of the World Wide Web and manage moreptop/Desc information from the World Wide Web.

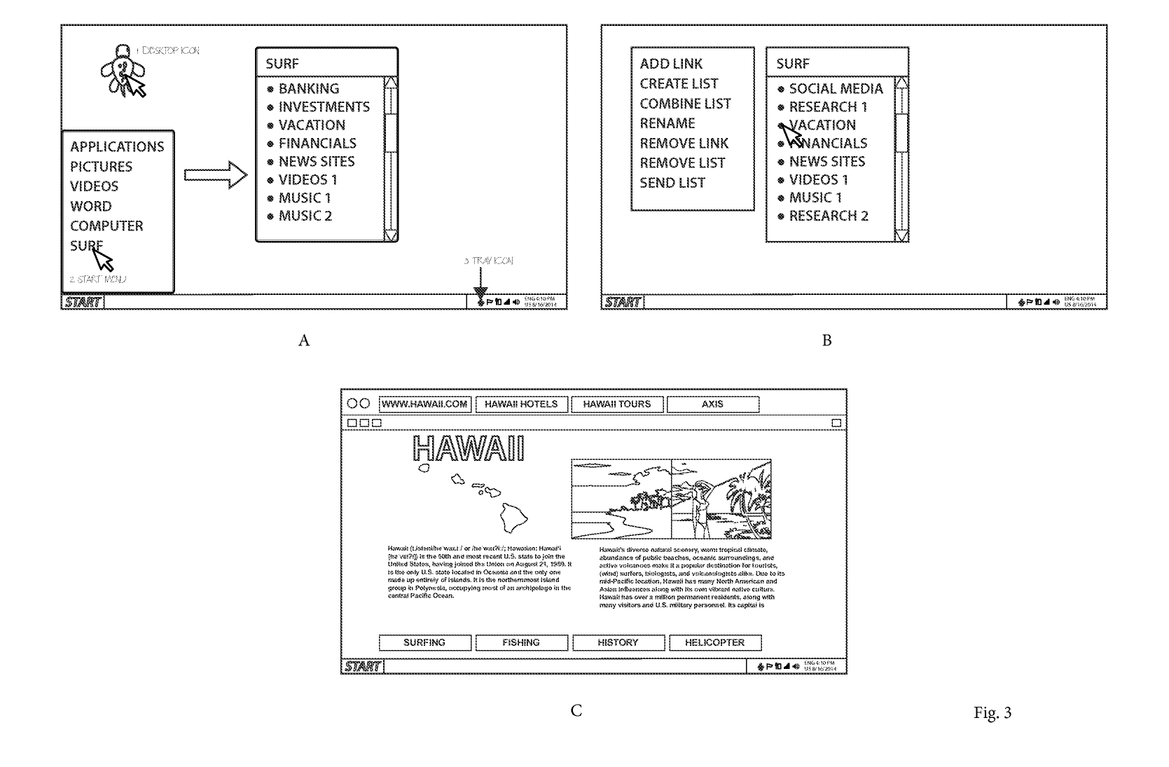

FIG. 1 illustrates the basic principle of the Product in an Android Setting. FIG. 1A shows the user selecting the desired URL/File grouping which opens the folder to be utilized as the user chooses (seen in FIG. 1B). By selecting the entire folder, the user is able to open all URLs/Files simultaneously in FIG. 2A. In FIG. 2B, the user is seen with his saved URLS/Files, selecting the desired website/file within their customized grouping. FIG. 3 illustrates the basic concept of the invention for Laptop/Desktop setting. In FIG. 3A, B, & C; we show the user accessing the product in a Windows setting. Three options allow the user to access the product in FIG. 3A. FIG. 3B demonstrates right click options available to the User. Finally coming to the last FIG. 3C, which demonstrates the product simultaneously furbishing the selected URL/File grouping desired by the user.

The invention allows a user to efficiently search the World Wide Web, in the invention is a computer implemented application which allows the user to save their searches in an organized manner like in a form of list or a menu or a catalogue, which a user can visit in his leisure. Also the invention, it provides a means of saving in a computer readable medium all the URLs of the website visited in at least one window of a web browsing client application, like a user may have opened multiple website in different tabs of a web browser, now in order to save the website the user may need to save each and every website individually, however with this invention will not need to do the tedious job of every tab of the web browsers. The invention would save all the URLs in the browser in a list and store it in a computer readable memory, which the user can access at later point of time, also the user can edited the list URLs, added information to the list of URLs, further a user may also create a list of URLs and delete it. But the invention would not the altering any information from the web browsers history. According to another embodiment of the invention a user may access a windows manager with the entire set of URI of the accessed websites, ready to be accessed by prompting a command via personalized algorithm. Furthermore, the invention allows the user to find saved websites, in a more efficient and convenient manner to find saved sites at a moment's notice. In one embodiment, the invention provides a means to compile the URLs in a computer readable storage medium like memory and allow the user to access the URL in the same window and simultaneously access the same URL in the web browsing client application like Mozilla or google chrome or safari etc.

In one objective, the invention provides a means to link multiple URLs to/from the web browser at the same time and provided a user friendly graphical user interface to increase the browsing efficiency of a user of the World Wide Web.

In a one objective of the invention, a user will access the invention by selecting icon of the application in the operating system which will contain the personalized list of the URL links When a user clicks on the icon of the application it will have a window with a list of links, for example vacation, then the web browser will open multiple tabs with multiple websites in a window, which the user had earlier accessed from the web browser.

Further if we have a web browser had opened with multiple tabs and multiple websites therein, the invention would provide a few options to the user in the browser, like one option would be there for saving all the tabs, this would avoid the tedious process of going to the file section of the browser then scrolling down the drop down menu then to click a option of save window or save tab, another option that the user will have is a quick save which will allow the user to access the list of saved searches, and in another option the invention provides the user with a menu with a list of actions to performed like edit the list of URLs, added information or website to the list of URLs, further a user may also create a list of URLs and is also allowed to delete it.

in a preferred embodiment of the invention, a user may add or remove link from a list of URLs, create, rename, remove a new list, also the user is allowed to combine multiple list or send a list.

Further the computer implemented system will produce a plurality of columns for comparisons of the lease agreement obtained from various website in the World Wide Web in the spreadsheet. Furthermore the spreadsheet will have column supported by a worksheet that will contain all the relevant information, necessary to provide a lease payment, and the user will have all the relevant information to ensure that the chosen dealer that is providing the lease agreement is in fact providing a reasonable lease agreement.

Moreover, the invention is a method for simultaneous organization and procurement of multiple files/links saved in tabs inside a windows browser, or a list of files from word/excel/office/etc, that are being accessed in a mobile or a PC etc.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. However, the method procures files simultaneously, saved from these programs, regardless of provider, for instance, a file from Word can be saved to a list with a file from Photoshop, and a group of tabs from the browser, to open simultaneously from one command from the user.

Although the invention has been explained in relation to its preferred embodiment, it is to be understood that many other possible modifications and variations can be made without departing from the spirit and scope of the invention.

I claim:

1) A computer implemented method for intelligent management of a plurality of active data files in a plurality of file systems, operated upon by a plurality of active applications, comprising:
identifying said plurality of active data files in a plurality of file system, operated upon by a plurality of active applications which are operably connected to said computer;
retrieving said identified plurality of active data files of said file system which is operated upon by said active applications which are operably connected to said computer;
grouping said plurality of active data files into a list using an algorithm;
storing in a storage medium of said computer said retrieved plurality of active data files operated upon in a plurality of active applications operably connected to said computer;
displaying through a graphical user interface, said grouped files on a display means of said computer.

2) The computer-implemented method of claim 1, wherein said algorithm is based on user interaction with an active data file from said one or more data files.

3) The computer-implemented method of claim 1, wherein said algorithm is further based on metadata describing said active data file.

4) The computer-implemented method of claim 2, wherein the metadata comprises document type, document access history, document edit history, keywords, or author information.

5) The computer-implemented method of claim 1, further comprising indexing the set of data files to enable searching of said set of data files.

6) The computer-implemented method of claim 1 further provides a means of creating, editing, adding and detecting of active data files from the list.
